(19) United States
(12) Patent Application Publication
(10) Pub. No.: US 2009/0204414 A1
(43) Pub. Date: Aug. 13, 2009

(54) Method and system to enable in-context pre-meeting dialogue and collaboration among invitees

(76) Inventor: Bharat Punjalal Shah, Delhi (IN)

Correspondence Address: MAXVALUEIP CONSULTING LLC, 11204 ALBERMYRTLE ROAD, POTOMAC, MD, 20854, US

(21) Appl. No.: 12/027,708

(22) Filed: Feb. 7, 2008

(51) Int. Cl. G06Q 10/00

(52) U.S. Cl. 705/1

(57) ABSTRACT

An embodiment of this invention enables in-context pre-meeting dialogue and collaboration among invitees and participants of meeting or event, using tools such as calendar products. An embodiment allows the invitees to send their responses on a meeting invite to other invitees and not limit or restrict the responses only to the meeting organizer. With in-context pre-meeting dialogue and collaboration features, an embodiment enables a more effective participation by the invitees for a more fruitful meeting or event.

### BACKGROUND OF THE INVENTION

Currently, event-organizing products, for example a calendar, while processing meeting requests, allow an invitee for a meeting to respond only to the meeting organizer (chair). The invitee's response, whether “accept”, “decline”, “delegate”, and so on, with or without comments, is sent only to the meeting organizer.

Hence, if an invitee wishes other invitees to be informed about his/her acceptance/decline of the invite or see his/her comments, s/he has to send a separate communication (e.g., email) to the rest of the invitees. When an invitee (user) responds to a meeting invite, either accepting or declining, s/he may like other invitees to see his/her comments.

Current state-of-the-art does not provide the invitees a method to send their responses on a meeting invite to other invitees, or allow the invitees to deliberate or collaborate while remaining within the context of the meeting and the meeting invite.

This concept of meeting management in this disclosure is also generalized to an event management tool, and the method related to that. Thus, we will use both terms “event” and “meeting” in this disclosure, to describe different embodiments of the invention.

### SUMMARY OF THE INVENTION

An embodiment of this invention provides features to event-organizing (e.g., calendar) products to allow the invitees to deliberate and collaborate within the context of the event invite. An embodiment allows the invitees send their responses on an event invite to other invitees and not limit or restrict the responses only to the event organizer (chair).

This embodiment is very useful in many ways, such as:
1. When the invitees want to collaborate among themselves and with the chair person about the proposed agenda for the event.
2. When some invitee(s) want selected invitees to be notified about their response (i.e. an acceptance/decline). Since some invitees may want to decide about participating in an event depending on whether some other invitees will attend.
3. When members of a sub-team want to ensure that someone from the sub-team attends the event.

By implementing this feature, an embodiment provides for “In Context” pre-event planning, dialogue and deliberations among the event participants, consequently leading to a more effective participation by the invitees.

### BRIEF DESCRIPTION OF THE DRAWINGS

FIG. 1 is a schematic diagram of the calendar products, while processing meeting requests.

FIG. 2 is a schematic diagram of the pre-meeting dialogue and collaboration among invitees.

### DETAILED DESCRIPTION OF THE PREFERRED EMBODIMENTS

In an embodiment of the invention, processing a response to an event invite needs to be extended so that the response can be sent to not only the event organizer, but to other selected invitees from among all the invitees. Such processing could ensure that such exchange of responses among the invitees and the event organizer occurs within the context (“In Context”) of the event.

In one embodiment, this is typically realized by adding the following steps:

1. The invitee, at the time of submitting his/her response (with or without comments) to the event request, is offered a list of all invitees to select those invitees to whom s/he wants the response sent. By default, the event organizer (chair) should receive all responses.

2. The response is then sent not only to the event organizer, but also to all the selected invitees.

3. The receiving invitees receive responses, such as event updates, with the facility to respond to them in the same manner as with the event originating message, for example, a meeting invite or e-mail.

4. The receiving invitees can respond to such responses as detailed previously in item 1 above.

5. In all cases, subsequent responses will always go to the event organizer. S/he will also have the same facility to respond as other invitees (as discussed previously in item 1 above).

Exchanging a series of responses among the invitees and the event organizer “In Context” of the event invite will facilitate multi-party interaction and collaboration, and it helps all invitees to accomplish all pre-meeting deliberations.

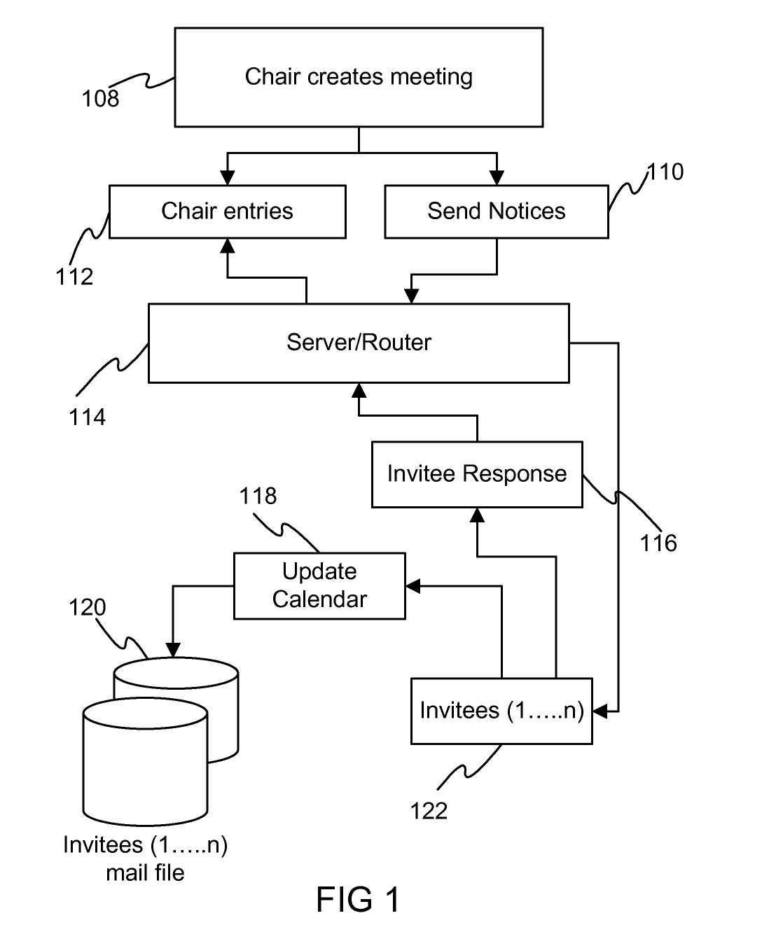

An embodiment of the invention is a method (FIG. 1) for use in calendar products, for processing meeting requests. In one embodiment, for a given operation, the meeting organizer (chair) creates event request (108), such as a meeting request, and sends the event invitation to selected invitees. The event organizing product, for example the calendar, creates a document in organizer's events record and emails a notice (110) document to each invitee.

The invitee has a choice of accepting or declining (116) the invite, for example a meeting request. In another embodiment, there may be various other options that are available to the invitee, such as delegating the event to another user, rescheduling the event, and so on. Various other options can be provided to the invitees and such options fall within the scope of the present invention, e.g. integration and communications with PDAs and cell phones. (120, 122, 210, for invitees)

All responses from the invitees are communicated back to the chair (112), for example, by means of an email, and updates in the invitee calendar (118). Various other options, such as a SMS, chat, phone call, etc., can be used to communicate with the chair (112) and the various means of communication with the chair (112) fall within the scope of the present invention. (e.g. using a server and a network (114))

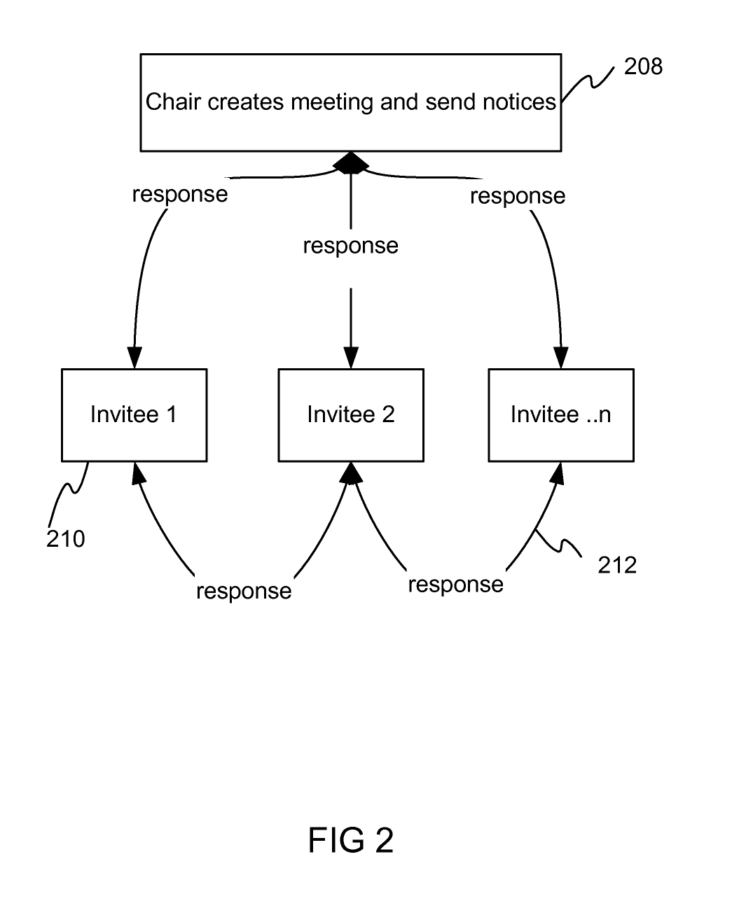

FIG. 2 is a schematic diagram of the pre-event dialogue and collaboration among invitees. In one embodiment, for a given operation, the event organizer (chair) creates event requests (208) and sends the invitation to the invitees. The response is then sent not only to the event-organizer, but also to all other selected invitees (212). The receiving invitees receive such responses as event updates, with the facility to respond to them in the same manner as the event invite. In one embodiment, when multiple responses are received, the responses may be categorized in ascending order or descending order or any other pre-determined order chosen by the invitee. In another embodiment, when one invitee is responding with comments, to avoid repeated confusion that may be created because of multiple responses, the response mechanism for other invitees can be temporarily locked, when one of the invitees is responding to the original event request that has been received.

Processing an event invite (meeting request) for more than one invitee involves individual invitees to check if s/he can send a response to the event invite to other invitees, in addition to the event organizer. Receiving invitees can then check if they receive such response from the other invitees, and whether or not they can respond to it further.

In one embodiment, the organizer may be provided with an option to block recipients from sending in further communication and provide an event directive, without an option for other selected invitees to respond.

An embodiment of the invention consolidates all the collaborations in the context of the meeting, so that the users do not have to leave the meeting invites and use e-mail.

In an embodiment, the event organizing products is a calendar system that allows invitees to deliberate/collaborate within the context of a meeting invite, wherein invitees should be allowed to send their responses on a meeting invite to other invitees and not limit/restrict the responses to the meeting organizer (chair), only. In a further embodiment, invitees of a meeting should be able to select the invitees (some or all invitees) who can receive his/her response to a meeting invite, in addition to the meeting chair. In yet another embodiment, the invitees should be able to respond to such (received) responses in the same manner as the meeting invite. For every response, the recipient should be able to send his/her response to all or selected subset of the recipients of that response, i.e., every response is processed in the same manner as a meeting invite, and the additional contents/comments generated are added to the calendar, thereby, keeping track of the discussion trail.

In a further embodiment, the invitees to a meeting should be able to collaborate within the context of the meeting, by using the responses to the invite/responses for sharing comments and their acceptance/decline for the meeting with the other selected invitees (a sub-set chosen by the invitee(s)). All such responses being consolidated in the meeting invite of the individual invitees.

In one embodiment, a method of enabling in-context pre-meeting dialogue and collaboration among meeting invitees is disclosed. A first entity invites two or more invitees to a meeting. Next, a first group is formed by grouping the first entity with the two or more invitees. Next, the first group is divided into multiple subteams, based on different tasks, goals, or interests. Next, a first invitee among the two or more invitees selectively responds to one or more of the members of the first group, about the intention of the first invitee among the two or more invitees to attend the meeting.

Subsequently, the first invitee among the two or more invitees selectively sends comments to one or more of the members of the first group. Next, the first invitee among the two or more invitees selectively performs in-context pre-meeting planning with one or more of the members of the first group. Next, the first invitee among the two or more invitees selectively collaborates with one or more of the members of the first group about an agenda of the meeting. Next, the first invitee among the two or more invitees selectively sets a condition to attend the meeting, based on attendance of one or more of the members of one or more of the multiple subteams.

Subsequently, the first invitee among the two or more invitees selectively sets a condition to act on the agenda of the meeting based on the actions of one or more of the members of one or more of the multiple subteams. Next, the first invitee among the two or more invitees selectively reviews the comments or e-mails exchanged between one or more of the members of one or more of the multiple subteams. Finally, meeting updates are coordinated with a calendar database.

A system, apparatus, or device comprising one of the following items is an example of the invention: meeting, event, meeting or event organizer, email, email server, server, client device, PDA, mobile device, cell phone, storage to store the invite messages or responses, task, goal, interest, response, comment, agenda, condition to attend, team, subteam, member, database, calendar, or any software, applying the method mentioned above, for the purpose of invitation or enabling in-context pre-event dialogue and collaboration among event invitees.

Any variations of the above teaching are also intended to be covered by this patent application.

1. A method of enabling in-context pre-meeting dialogue and collaboration among meeting invitees, said method comprising:
a first entity inviting two or more invitees to a meeting, using an email system comprising a server, a client device, and a storage device;
grouping said first entity with said two or more invitees into a first group;
dividing said first group into multiple subteams, based on different tasks, goals, or interests;
wherein said multiple subteams comprise more than one invitee, but less than all said meeting invitees;
a first invitee among said two or more invitees selectively responding to one or more of members of said first group, about intention of said first invitee among said two or more invitees to attend said meeting;
said first invitee among said two or more invitees selectively sending comments to one or more of the members of said first group;
said first invitee among said two or more invitees selectively performing in-context pre-meeting planning with one or more of the members of said first group;
said first invitee among said two or more invitees selectively collaborating with one or more of the members of said first group about an agenda of said meeting;
said first invitee among said two or more invitees selectively setting a condition to attend said meeting based on attendance of one or more of the members of one or more of said multiple subteams, and said first invitee selectively sending response, using said email system, to inform specific members of specific subteams, about said set condition to attend said meeting by said first invitee;
said first invitee among said two or more invitees selectively setting a condition to act on said agenda of said meeting based on actions of one or more of the members of one or more of said multiple subteams, and said first invitee selectively sending response, using said email system, to inform specific members of specific subteams, about said set condition to act on said agenda of said meeting by said first invitee;
said first invitee among said two or more invitees selectively reviewing comments or e-mails exchanged between one or more of the members of one or more of said multiple subteams;
said first invitee among said two or more invitees selectively delegating attendance of said meeting to specific members of specific subteams;
wherein a response from specific members of specific subteams is temporarily locked, to avoid repeated confusion that is created because of multiple responses; and
coordinating updates of said meeting with a calendar database.
